(19) United States
(12) Patent Application Publication
(10) Pub. No.: US 2017/0332544 A1
(43) Pub. Date: Nov. 23, 2017

(54) DATA DRIVEN INDOOR FARMING OPTIMIZATION

(71) Applicant: iUNU, LLC, Seattle, WA (US)

(72) Inventors: Travis Anthony Conrad, Bellevue, WA (US); Adam Phillip Takla Greenberg, San Francisco, CA (US); Kyle Terrence James Rooney, Seattle, WA (US)

(21) Appl. No.: 15/286,498

(22) Filed: Oct. 5, 2016

Related U.S. Application Data
(60) Provisional application No. 62/237,467, filed on Oct. 5, 2015.

(51) Int. Cl. A01B 79/00; G06N 99/00; A01G 7/04; G05B 19/00; A01G 9/00; G06F 7/00

(52) U.S. Cl. CPC A01B 79/005; G06N 99/005; A01G 7/04; A01G 9/00; G06F 7/00; G05B 19/00

(57) ABSTRACT

Data driven indoor farming optimization may provide autonomous decision making that maximizes crop yield. One or more specifications and one or more constraints on resources for a crop being monitored may be received at computing devices. The computing devices may generate a simulation using a machine learning algorithm to determine whether the one or more specifications and the one or more constraints result in a grow solution for the crop. The simulation may be constrained by historical data on one or more variables that affect crop production. The computing devices may receive a modification to a constraint in the event that the simulation failed to generate a grow solution for the crop. On the other hand, if the simulation generates a grow solution for the crop, the simulation may be run to predict growth of the crop at specific time intervals of a grow cycle for the crop.

### CROSS REFERENCE TO RELATED PATENT APPLICATION

This application claims priority to U.S. Provisional Patent Application No. 62/237,467, filed on Oct. 5, 2015, entitled “Data Driven Indoor Farming Optimization,” which is hereby incorporated by reference in its entirety.

### BACKGROUND

Control systems are becoming increasingly ubiquitous and important in today's highly connected and data-driven world. With the Internet of Things/Internet of Everything (IoT/IoE) revolution in full swing, the number of connected devices is expected to increase dramatically. The World Economic forum has estimated this number to be 50 billion devices by 2020 while other industry estimates are as high as 100 billion (Hammersmith Group). One industry poised to benefit dramatically from the increasing interconnection of devices is indoor farming. Indoor farming has gained real traction in the last five years, examples of which include a former Sony Corporation semiconductor factory converted into the world's largest indoor farm. The 25,000 square feet of this indoor farm produces 10,000 heads of lettuce per day with 40% less power, 80% less food waste, and 99% less water use than traditional outdoor farming.

Conventional industrial control systems for indoor farming are typically binary systems that do not allow much freedom in the way the system is controlled. For example, if a grow room is over the temperature set on the controller, the controller will simply ensure that the A/C units are on. If the room reaches a temperature lower than what the controller is set to, the A/C unit will shut off. This is typically done through the use of a proportional-integral-derivative (PID) controller. A PID controller calculates an error value as the difference between a set point and a measured process variable. Although a PID controller uses three different control equations, the function of the controllers remains the same. This is what is meant by a binary level of control, i.e., having only the ability to control on/off functions to achieve a desired set point.

Most control systems for indoor farming run in this manner, with no level of intelligence or data-driven decision making abilities. The newest controllers, such as the iPonic 600, may claim to be highly customizable and come with additional binary features such as high temperature shut-off. However, their core functions are the same as any other controller on the market: temperature, humidity, CO₂ level, and lighting power control.

The limitations of these control systems are inherent to the sensors employed as well as the lack of a software capable of managing more advanced features. With a traditional controller, a user cannot see how the temperature changed throughout the day. Instead, such control system may at best provide a minimum/maximum temperature for the day. The user also cannot access this information remotely from a connected device, but must be in physical proximity to the controller. There are systems that incorporate the ability to remotely view and control an indoor grow room, but they are very costly and the limited functions of a typical controller remain the bottle neck. This leads into the next limitation of traditional control systems: even systems that allow remote access lack the ability to not only collect data and analytics but also make autonomous decisions based on the information gathered without user input. If an issue presented itself that required more than adjusting a set point e.g., a reservoir was overflowing, the remote user would likely only be able to watch in dismay.

In addition, traditional control systems for indoor farming lack the ability to optimize a grow cycle in terms of cost vs. benefit. For example, if a grow cycle happens to be during peak hours, a user may be paying a much higher rate for the same return assuming all other variables are constant.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 is a context diagram for an exemplary data-driven control system incorporating near-field communication (NFC)/radio-frequency identification (RFID) to enable interaction with the crop in a desired location.

FIG. 2 is a flowchart illustrating exemplary execution of a data-driven control system using an array of imaging technologies and machine learning to optimize plant growth.

FIG. 3 is a flowchart illustrating exemplary execution of software for optimizing an indoor farm via machine learning.

FIG. 4 is a block diagram illustrating a representative computing architecture on which indoor farming optimization in accordance with various embodiments is implemented.

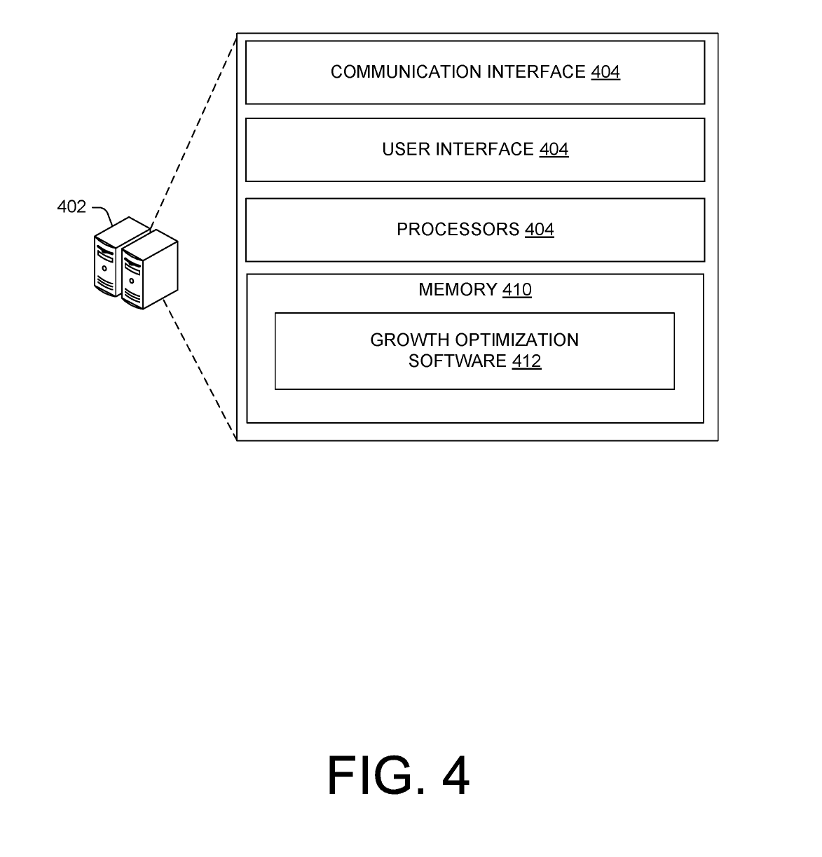

### DETAILED DESCRIPTION

### Context and Conceptual Framework

As the population continues to increase, the importance of efficiency in the way food is produced increases even faster. Further efficiencies may be achieved with the use of control systems that incorporate IoT, more specifically Industrial IoT (IIoT), which brings about capabilities much more advanced than a typical proportional-integral-derivative (PID) controller commonly used in industrial control systems can offer. Not only would the level of control be enhanced, but the interactivity and engagement into any aspect of an indoor farm would give those users the ability to understand with high resolution what exactly is happening with any given area, at any given time, from any given location. For example, if a user wanted to view the data and/or analytics for a crop, e.g., temperature, humidity, CO₂ level, lighting cycles, photosynthesis rate etc., the user can scan an NFC/RFID tag for that area and be directed to a hosted page that contains all relevant data. The host page may provide the ability to filter the data depending on what the user wants to know, e.g., instantaneous or historical data as well as analytics determined by the system. If a user wishes to interact with the crop area remotely, the utilization of cameras coupled with the appropriate software would allow the same level of interaction.

Crop interaction as described above currently does not exist, but rather relies on manual processes. The status quo for crop inspection and evaluation presently is a result of the eye and knowledge of the user, a highly variable criterion from person to person. Standards can be put in place to assist, but the interpretation of the standards is again left to the user.

In terms of efficiency gains achieved from indoor farming, predominantly the gains are a result of the hardware being used as well as the growing method. For example, 99% less water use is due to the lack of a soil medium, causing saturation to occur quicker. With aeroponics, roots are misted with no medium to speak of, other than air of course. The 40% reduction in power is due to LED lighting fixtures themselves being more efficient than HID lighting technologies since they do not use the high amperage of AC current to create an arc through the high pressure gas filament, such as a high pressure sodium lamp. These intrinsic gains due to hardware and growing style may be further improved upon through the use of an entirely networked, data driven control system paired with advanced sensors not yet common to the industry.

One example of such a sensor that would be that of a near infra-red (IR) camera. A near IR camera has the ability to detect how much visible light, typically 550 nm to 700 nm, is being absorbed by chlorophyll and how much near-IR light, 730 nm to 1000 nm, is being reflected by the cellular structure of the plant. The most useful information with respect to farming obtained using a near IR camera is known as the normalized difference vegetation index (NDVI). With the advent of smaller, more cost effective near IR lenses the possibilities of incorporating the technology into an indoor farm has become not only possible but practical for large scale indoor farms. NDVI is calculated rationally from the visible (VIS) and near-infrared (NIR) light reflected by vegetation (NIR−VIS/NIR+VIS). Since the NIR and VIS measurements are themselves ratios, they take on values between 0.0 and 1.0. Thus, the value of NDVI may vary from −1.0 to 1.0. Healthy vegetation absorbs most of the visible light that comes in contact with the leaf surface and reflects a large portion of the near IR. By analyzing a canopy with an NDVI camera, a user would be able to quickly locate areas that were reflecting more visible light as a result of chlorophyll deficiencies and take corrective actions. These sensors have been used in traditional agriculture, usually called optical crop sensors, however this technology has yet to be integrated into a system that can calculate the metabolic rate of photosynthesis, respond to the measurements, and take corrective actions if necessary. If corrective actions are taken, a user would be notified through push notifications, or a similar method. An NDVI camera can be mounted in a stationary position or to an autonomous drone to allow scheduled crop fly overs and data acquisition. The drone being autonomous mean that it is capable of taking off and docking itself at a prescribed or artificially learned interval.

Another remote sensing technology of value to agriculture that has not been incorporated into indoor farming control systems is the use of LIDAR. LIDAR is used throughout many different industries from archaeology to robotics. For agricultural applications, LIDAR has been used to create topographical maps that indicate which areas on a farm are most productive and thus where to apply costly fertilizer. Indoors, as part of an exemplary control system, a LIDAR sensor can determine biomass/crop density. When integrated into an exemplary data-driven control system, LIDAR may be used to determine necessary changes in a nutrient regimen, feeding schedule, environmental condition, etc., based on a set optimal density of a crop versus what is measured. An exemplary LIDAR device can be mounted stationary or to an autonomous drone to gather crop density data and map the results.

An additional technology not traditionally used in indoor farming is computer vision. Computer vision is the science responsible for the study and application of methods which enable computers to understand the content of an image. The use of computers in agriculture has been on the rise in recent years as the cost of computational power and sensors diminishes and becomes more cost effective than manual labor. Computer vision is currently used in agriculture primarily as a non-destructive quality inspection system. For the exemplary control system described herein, computer vision would not only serve as a tool for visual inspection, but would enable the system to react to issues not seen by the NDVI or LIDAR systems. For example, a nitrogen deficiency can be detected by the NDVI camera as a lower relative index value, but this is a low resolution measurement, i.e., the system would alert the user that photosynthesis in a certain area was at a lower rate relative to an adjacent area due to chlorosis within the leaves, which results from the absence of chlorophyll. An exemplary system as described herein cannot act upon NDVI data alone, as the cause of the lack of chlorophyll would be undetermined and thus corrective action cannot be taken. Using embedded computer vision, an exemplary system can evaluate the characteristics of the deficient leaf, check the images against a database of conditions, and determine what the deficiency is as well as initiate a corrective action e.g., increase nitrogen content for that crop area. An exemplary system would automatically track and log the sequence of events while allowing the user to visualize the data and analytics at any time from any network connected device e.g., mobile phone, tablet, computer, etc.

Beyond hardware, the use of algorithms coupled with an exemplary control system to increase efficiency are also implemented. With increases in efficiency come minimized costs, and minimized environmental impact. An exemplary system may possess the ability to suggest what time of day a user should run high energy use equipment to achieve the lowest cost. An exemplary system may also possess the ability to obtain a maximum budget per day from a user, and through an established priority scheme may adjust energy consumption to be perfectly in sync with that budgeted maximum. Beyond these functions, an exemplary system can show a user what their total savings were over time compared to what the costs would have been had the system not been optimizing resource use. Other features that benefit a data-driven optimization system may include a sonication system that can enhance plant growth as well as deter pests with high frequency sound.

### Introduction to a Data Driven Indoor Farming Optimization System

There is a need to have a control system for indoor farming that is capable of collecting, analyzing data and administering corrective action based on that data using non-conventional sensors and technology such as NIR, LIDAR, and computer vision. Additionally, there is a need to have a system for indoor farming that can advise users on optimal times to use high energy use equipment as well as dynamically respond to budgetary parameters set by the user. Moreover, there is a need to incorporate autonomous drones into an indoor garden environment to alleviate the labor of data collection.

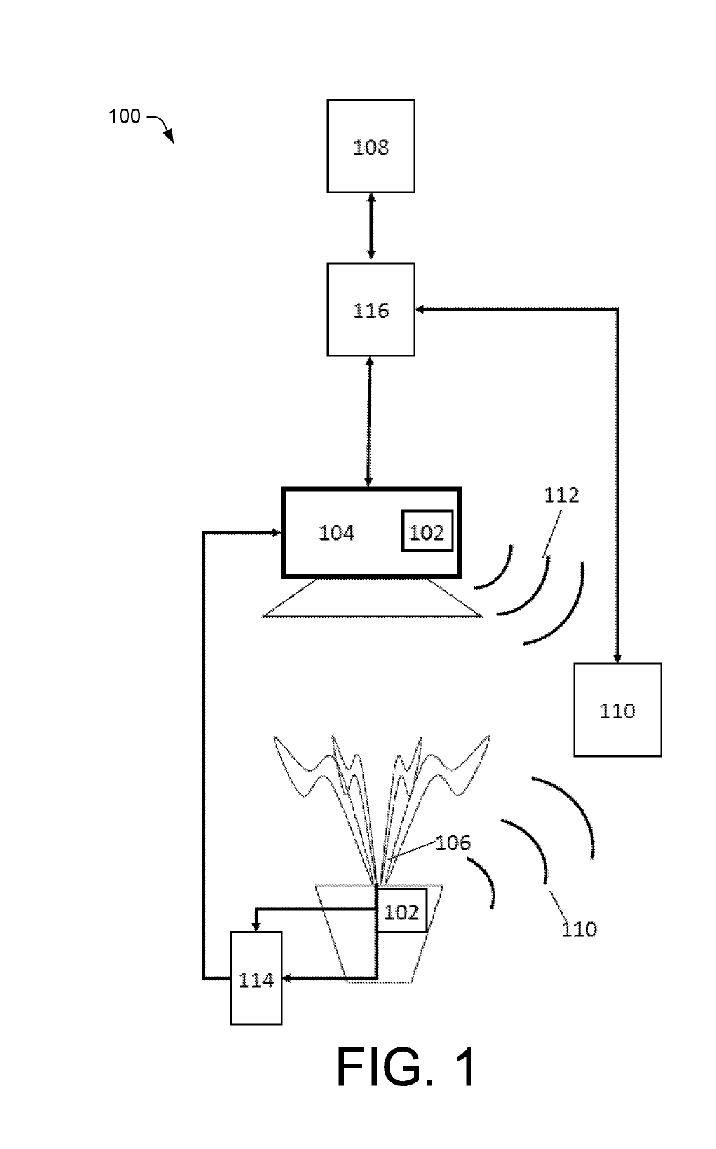

FIG. 1 illustrates an example environment 100 of a data driven control system configured with near-field communication that allows a user to access information about a particular crop and/or area of an indoor farm through a networked device connected to a database. As illustrated, a wireless communication module 102 (e.g., a controller, a router, etc.) may be positioned in an area or near a component of an indoor farm, such as a lighting fixture 104 or a sensor that is in proximity to the crop 106. A user may access data and analytics about a certain crop or area stored in a database 108 via wireless communication by utilization of a network enabled device 110 with a configured wireless communication module 102. The database 108 may reside on a server or a computing cloud. The network enabled device 110 must capable of interpreting wireless communication signals 112. The network enabled device 110 may access the database 108 through a network interface 116. The user may access data obtained by network connected sensors 114 placed throughout the farm through a URL that is accessed by use of the wireless communication module 102.

In various embodiments, the wireless communication module 102 may be any sort of communication device that enables a user to access information wirelessly with a properly enabled device. In some embodiments, a wireless communication module 102 may allow one-way communication such as RFID, IR control, etc., or two-way communication such as NFC, Bluetooth, etc. In some embodiments, the wireless communication device serves as the gateway to data and analytics stored in a database with regard to a crop location that is within user proximity. In at least one embodiment, one or more of the sensors 114 may automatically establish communication connections with the wireless communication module 102. In such an embodiment, a sensor or the wireless communication module 102 may detect a heartbeat signal that is transmitted by the other device upon coming within a certain range of each other. In response, the device that received the heartbeat signal may send an acknowledgment signal. The acknowledgment signal may trigger the two devices to negotiate common transmission parameters of a communication connection via additional communication signals that are exchanged between the two devices. The common transmission parameters may include data exchange speed, data exchange protocol, transmission mode, data flow control, data encryption scheme, and/or so forth. Once the common transmission parameters are negotiated, the sensor and the wireless communication module 102 may exchange data via the communication connection. The sensor and the wireless communication module 102 may continue to use the communication connection until one of the devices sends a connection termination command to the other device or the communication connection times out due to the lack of communication signals exchanged for a predetermined period of time. In this way, the sensors 114 may automatically connect with the wireless communication module 102. For example, a sensor that is mounted on an autonomous drone may automatically establish a communication connection with the wireless communication module 102 when the drone flies to within communication range of the device.

In some embodiments, the lighting fixture 104 may be any lighting fixture that incorporates a technology that is used for horticulture, such as but not limited to high pressure sodium, metal halide, LED, light emitting plasma, advanced plasma, fluorescent and ceramic metal halide.

In some embodiments, the crop 106 may be any living organism that is being intentionally cultivated. In some embodiments, the database 108 may be any storage media, local or remote, capable of storing data collected by sensors 114. Data may be retrieved from the database by a user in order to view data and analytics of the correlated area. In various embodiments, the network enabled device 110 is any device capable of accessing a network to retrieve data and analytics. The network enabled device 110 may be in the form of a mobile phone, a tablet, a personal computer, or any other form of networkable terminal. In various embodiments, the wireless communication signal 112 may be any signal that is emitted from a wireless communication module 102 that can be interpreted by a network enabled device 110.

In some embodiments, sensors 114 may be any sensor as described in the detailed description as well as others not previously mentioned such as but not limited to: Soil moisture, temperature, humidity, CO₂, soil temperature, NIR, LIDAR, computer vision, infrared (thermal imaging), ultrasound, and optical light sensor. In various embodiments, a network interface 116 may be any system of software and/or hardware interface between the network enabled device 110 and the database 108. A network interface 116 may also connect a networkable light fixture 104 to a database 108.

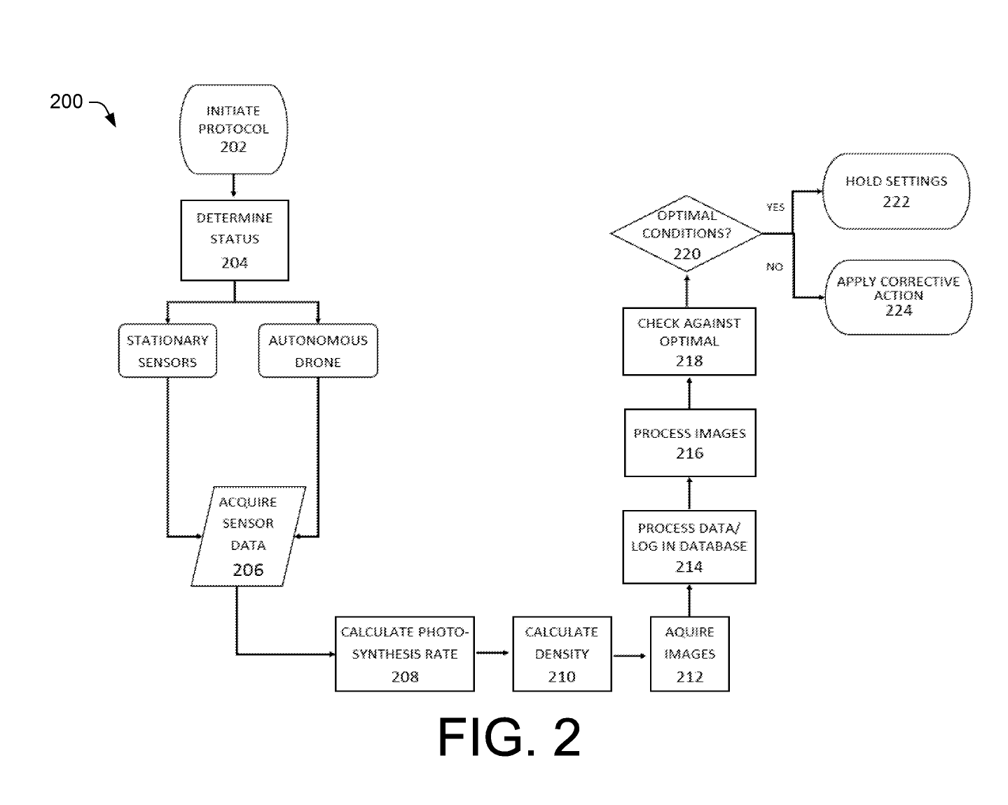

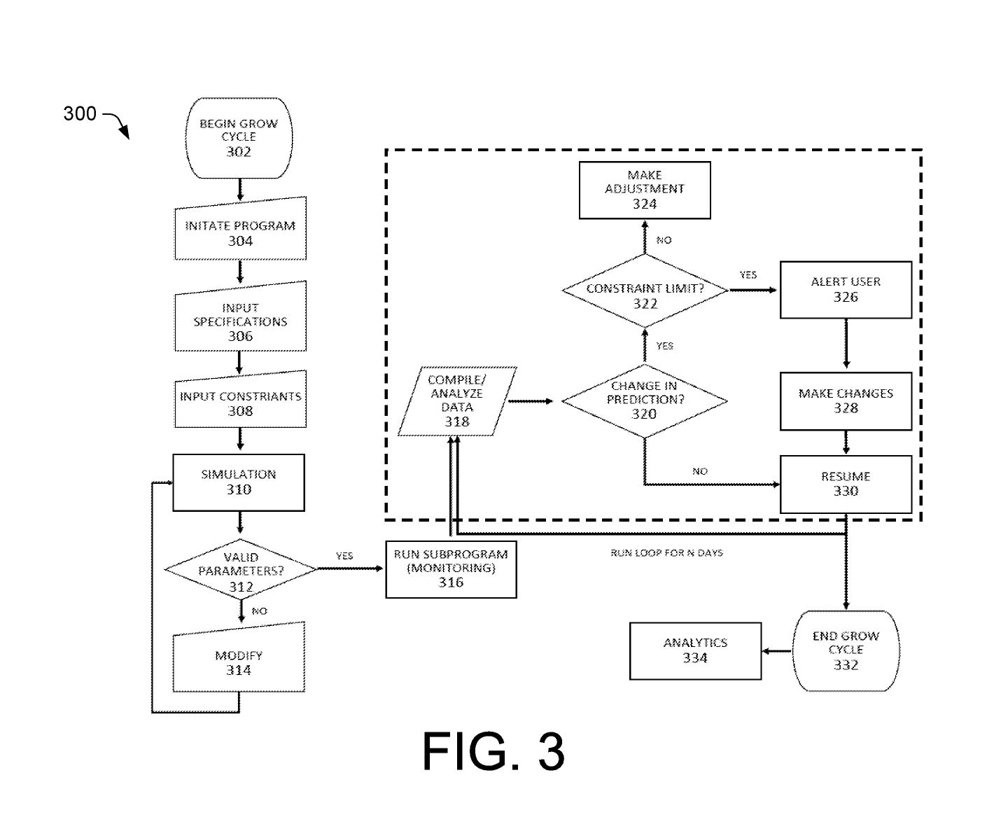

FIGS. 2 and 3 present illustrative processes for performing data driven indoor farming optimization. Each of the processes is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

FIG. 2 illustrates an exemplary execution 200 of a data-driven control system using an array of imaging technologies and machine learning to optimize plant growth. The processing including initiating a set protocol established by the user, a crop status determination done through use of sensors that are stationary or mounted to an autonomous drone, calculation of parameters relevant to sensor data, processing and logging of data, checking results against optimum settings, and applying corrective actions if necessary. This process includes, at block 202, the initiation of the user determined protocol for data acquisition.

At block 204, the status of the indoor farm environment is determined through use of sensors that are either mounted on a stationary structure or mounted to a mobile platform, such as a drone. Stationary sensors would likely be used in smaller indoor farming environments while a drone can handle a larger space without investment in additional sensor hardware. At block 206, data is acquired through use of all relevant sensors including, but not limited to, near-infrared (NIR), light detection and ranging (LIDAR), IR (thermal imaging), ultrasound, and visual imaging.

At block 208, calculations based on sensor readings begin, in this example photosynthesis is calculated. Using a near IR camera, a normal difference vegetative index (NDVI) is generated which allows the system to visualize the ratio of visible light to NIR light being reflected, which provides insight into how much chlorophyll is present. Based on NDVI readings, metabolic rate of photosynthesis can be calculated by the system and evaluated against the entire crop.

At block 210, sensor readings from the LIDAR sensor are calculated to determine crop density, which can in turn discover areas of low light or low nutrient absorption relative to adjacent or similar crops.

At block 212, images are acquired from relevant optical sensors, such as but not limited to photo cameras and thermal cameras. At block 214, all collected sensor data is processed and logged into a database for record keeping as well as the generating of analytics that may expedite the identification of issues within an indoor farm.

At block 216, images obtained by optical sensors are processed using computer vision algorithms. The computer vision algorithms may use classifiers to recognize crops and quantify crop characteristics, conditions, states, etc. For example, the classifiers may be trained using various approaches, such as supervised learning, unsupervised learning, semi-supervised learning, naïve Bayes, Bayesian networks, decision trees, neural networks, fuzzy logic models, and/or probabilistic classification models. Thermal camera readings may be used to determine reasons for unusual heat collection, e.g., eddy currents, and may allow the system to make HVAC corrections based on the thermal map. Photo camera data, in conjunction with computer vision, may be used to help identify deficiencies, for example locating necrosis or chlorosis in leaves due to lack of magnesium or nitrogen, respectively.

At block 218, processed data is checked against optimal parameters determined by the system based on relevant characteristics, such as but not limited to crop type and maturity. At block 220, the system determines whether or not the measured and processed data match that of what is determined to be optimal. At block 222, if the system determines target optimal conditions are present, no corrective action will be taken and all set points and parameters will be maintained. At block 224, if the system determines target optimal conditions are not met, corrective action is taken, potentially without user input, to correct the deficiencies detected by the imaging technology.

FIG. 3 illustrates an exemplary execution 300 of a software for optimizing an indoor farm via machine learning. The optimization may provide both resource and financial savings. Processes included to achieve this goal begin with the initiation of a grow cycle and subsequently the optimization program. A user inputs specifications and constraints which enable a simulation of the grow cycle to begin. If the grow cycle is valid, a sub-program begins which handles the day to day monitoring of the grow cycle with capabilities to adjust parameters with no user input so long as constraints are maintained. If constraints are approached, the user is notified and may make appropriate changes. Once the grow cycle completes, a detailed report of analytics is generated displaying overall savings as well as a comparison to what would have been spent had control of adjustments been left to the user. The process begins at block 302, the beginning of a grow cycle for an indeterminate crop.

At block 304, an exemplary optimization software is initiated by the user. At block 306, the user inputs specifications relevant to the crop being monitored such as but not limited to, crop species, expected grow cycle length, growing style/medium, and geographical location for growing the crop. At block 308, constraints the user deems relevant are input such as but not limited to, daily budget for electricity, daily maximum water use, and target cost per unit weight of produce.

At block 310, a simulation based on the set specifications and constraints is run to determine feasibility for the crop being grown. In various embodiments, the simulation may perform demand side analysis based on the inputted specifications and/or constraints via machine learning. Types of machine learning algorithms used may include decision tree learning, association rule learning, artificial neural networks, inductive logic, support vector machines, clustering, Bayesian networks, reinforcement learning, representation learning, similarity and metric learning, and sparse dictionary learning. The machine learning algorithms may perform single variable optimization, N-variable optimization, or N-dimensional (within limits) vector analysis of variable relationships. For example, the simulation may model operating high energy equipment off peak hours, and/or determine the best ratio of yield to cost e.g., producing 1000 grams for $500 vs. producing 500 grams for $175, etc.

At block 312, the simulation determines whether or not the specifications and constraints for a particular crop result in a solution or non-solution, taking into account inputs such as but not limited to, historical data of price fluctuations for utility services (e.g., water, electricity, heat etc.), weather patterns, and any other variables that can affect cost of production. At block 314, pending the simulation results in a non-solution, the user is prompted to modify inputs, typically but not limited to constraints on cost of production. At block 316, pending the simulation results in a solution, a sub-program is initiated which begins the monitoring process. At block 318, data is compiled on usage of utility services, fertilizers, etc., for a specified time interval (e.g., daily, weekly) and is analyzed and compared to the generated growth prediction.

At block 320, the software determines whether or not the real world grow cycle is on track with the growth prediction generated by the simulation. If the grow cycle is still on track, the system will act in reference to block 330. At block 322, pending a determination that a change in the growth prediction had occurred, the software determines whether or not a constraint limit input at the beginning of the sequence has been reached.

At block 324, pending a constraint has not been reached, the system automatically makes resource allocation adjustments to realign the grow cycle with the optimal configuration determined by the simulation. For example, if the system determines electricity is less expensive for a certain time period, the system may incrementally adjust the cycle to reside within the most cost-effective timeframe. In another example, if the system determines that an additional amount of a resource (e.g., water) may be distributed to the crop, the system may increase the dispersion of the resource. At block 326, pending a constraint has been reached, the system alerts the user via a network enabled device as described in detail above with regard to FIG. 1. At block 328, the user makes changes to the inputs in order to reach a solution as determined by the software's prediction algorithm.

At block 330, the software resumes either through no change in the original prediction or through modification to specifications and/or constraints that result in a solution. Blocks 318 through 330 are run in a loop for N days depending on the crop.

At block 332, the grow cycle ends and the software proceeds to analyze the data. At block 334, the software generates analytics from data collected throughout the grow cycle which displays results such as but not limited to, total cost of the grow cycle, cost per day, cost broken down by category, a comparison of what the grow cycle would have cost if the software had not been managing it, expected yield, and ratio of yield to a number of inputs such as but not limited to, yield per dollar and yield per unit of energy. The benefits of such a system are many over the status quo. The use of more advanced sensors creates an advanced level of visibility and potential control not yet seen in an indoor farming environment. The ability to utilize wavelengths not visible to the human eye or traditionally incorporated sensors allows the ability to visualize the health of a plant with incredible resolution. Beyond this, the increased resolution granted by NIR, IR, LIDAR, and photographs enhanced with computer vision allows for more streamlined integration into a control system that can take action without user input.

The embodiments described herein may be implemented in software that runs on one or more computing devices 402. In some instances, the network enabled device 110 may be an embodiment of the computing device 402. The one or more computing devices 402 may be equipped with a communication interface 404, a user interface 406, one or more processors 408, and memory 410. The communication interface 404 may include wireless and/or wired communication components that enable the computing devices to transmit or receive data via a network, such as the Internet. The user interface 406 may enable a user to provide inputs and receive outputs from the computing devices. The user interface 406 may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

Each of the processors 408 may be a single-core processor or a multi-core processor. Memory 410 may be implemented using computer-readable media, such as computer storage media. Computer-readable media includes, at least, two types of computer-readable media, namely computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD), Blu-Ray, or other optical storage, magnetic cassettes, magnetic tape, magnetic disk storage or other magnetic storage devices, or any other non-transmission medium that may be used to store information for access by a computing device. In contrast, communication media may embody computer readable instructions, data structures, program modules, or other data in a modulated data signal, such as a carrier wave, or other transmission mechanism. As defined herein, computer storage media does not include communication media. Accordingly, in some embodiments, the one or more computing devices 402 may execute a growth optimization software 412 that performs the data driven crop growth optimization functionalities described herein.

The embodiments may provide a more controllable, reliable, and high resolution means of interacting with indoor farming. Data driven optimization may increase efficiency of the hardware employed to minimize costs as well as environmental impact. The embodiments use advanced sensors, data-driven controllers, imaging technologies such as ultrasound, NIR, LIDAR, and computer vision, as well as a completely networked system capable of initiating, monitoring, and recording corrective action. The embodiments may further make use of autonomous drones to eliminate labor associated with constantly gathering data. Thus, by utilizing a system capable of making decisions within set guidelines, the labor used to produce food indoors may be substantially reduced. Not only this, but environmental impact and strain on the grid is managed and minimized. As farming continues the trend of moving indoors, managing these variables will become exponentially more important. With the use of data driven indoor farming optimization as described herein, the possibility of indoor farming becoming truly sustainable is within reach.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
receiving, at one or more computing devices, one or more specifications and one or more constraints on resources for a crop being monitored;
generating, at the one or more computing devices, a simulation using a machine learning algorithm to determine whether the one or more specifications and the one or more constraints result in a grow solution for the crop, the simulation being further constrained by historical data on one or more variables that affect crop production;
receiving, at the one or more computing devices, a modification to at least one constraint following the simulation failing to generate a grow solution for the crop; and
running, at the one or more computing devices, the simulation to predict growth of the crop at specific time intervals of a grow cycle for the crop following the simulation generating a grow solution for the crop.

2. The computer-implemented method of claim 1, further comprising:
monitoring usage of resources and growth of the crop at the specific time intervals during a production of the crop;
determining whether the growth of the crop at the specific time interval is on track with a predicted growth of the crop at the specific time interval; and
adjusting an allocation of a resource for growing the crop in response to determining that a corresponding constraint on the resource has not been reached in order to realign the growth of the crop at the specific time interval with the predicted growth of the crop at the specific time interval.

3. The computer-implemented method of claim 2, further comprising providing an alert in response to determining that the constraint on the resource has been reached.

4. The computer-implemented method of claim 3, further comprising:
generating a new grow solution for the crop via the simulation based at least on a modified constraint following the alert, the simulation providing new predicted growth of the crop at the specific time intervals;
determining whether the growth of the crop at an additional specific time interval is on track with the new predicted growth of the crop at the additional specific time interval; and
adjusting an allocation of the resource or an additional resource for growing the crop in response to determining that the constraint on the resource or an additional constraint on the additional resource has not been reached in order to realign the growth of the crop at the additional specific time interval with the new predicted growth of the crop at the additional specific time interval.

5. The computer-implemented method of claim 2, wherein the determining includes determining the growth of the crop via one or more sensors, the one or more sensors including a near infrared (NIR) sensor, a light detection and ranging (LIDAR) sensor, a thermal sensor, an ultrasound sensor, or an optical sensor, further comprising storing sensor data collected by the one or more sensors in a data store.

6. The computer-implemented method of claim 2, wherein the determining includes determining a growth of at least one plant via a normal difference vegetative index (NDVI) that is generated using infrared data of at least one plant as captured by the NIR camera, the NDVI providing a visualization of a ratio of visible light to NIR light that is reflected by the at least one plant that is used to calculate a metabolic rate of photosynthesis for the at least one plant.

7. The computer-implemented method of claim 2, wherein the determining includes determining crop density based on sensor readings from a light detection and ranging (LIDAR) sensor, the crop density indicating an area of low light or an area of low nutrient absorption by at least one plant.

8. The computer-implemented method of claim 2, wherein the determining includes processing images obtained by an optical sensor via a computer vision algorithm to identify a specie of crop, a quantity of the crop, or one or more states associated with the crop, wherein the states includes at least one of an eddy current that causes heat collection in a particular growing area for the crop, necrosis in a leave of a plant of the crop, or chlorosis in a leave of the plant of the crop.

9. The computer-implemented method of claim 1, further comprising:
analyzing data on usage of resources and growth of the crop for the grow cycle of the crop; and
generating analytics that provide at least one of a total cost of the grow cycle for the crop, a cost per day for production of the crop, yield of the crop per dollar, yield of the crop per unit of energy.

10. The computer-implemented method of claim 1, wherein the one or more specifications include at least one of a crop specie of the crop, a grow cycle length of the crop, a geographical location for growing the crop, or a growth medium for growing the crop, wherein the one or more constraints include at least one of daily budget for a utility service used for growing the crop, maximum water use for growing the crop, or target cost per unit weight of the crop produced, and wherein the one or more variables include a price of a utility service provided for growing the crop or a weather pattern at the geographical location.

11. A system, comprising:
one or more processors; and
memory including a plurality of computer-executable components that are executable by the one or more processors to perform a plurality of actions, the plurality of actions comprising:
generating a simulation using a machine learning algorithm to determine whether one or more specifications and one or more constraints on resources that regulate a growth of a crop result in a grow solution for the crop, the simulation being further constrained by historical data on one or more variables that affect crop production;
receiving a modification to at least one constraint following the simulation failing to generate a grow solution for the crop;
running the simulation to predict growth of the crop at specific time intervals of a grow cycle for the crop following the simulation generating a grow solution for the crop;
monitoring usage of resources and growth of the crop at the specific time intervals during a production of the crop;
determining whether the growth of the crop at the specific time interval is on track with a predicted growth of the crop at the specific time interval; and
adjusting an allocation of resource for growing the crop in response to determining that a corresponding constraint on the resource has not been reached in order to realign the growth of the crop at the specific time interval with the predicted growth of the crop at the specific time interval.

12. The system of claim 11, wherein the actions further comprise providing an alert in response to determining that the constraint on the resource has been reached.

13. The system of claim 11, wherein the actions further comprise providing an alert in response to determining that the constraint on the resource has been reached.

14. The system of claim 12, wherein the actions further comprise:
generating a new grow solution for the crop via the simulation based at least on a modified constraint following the alert, the simulation providing new predicted growth of the crop at the specific time intervals;
determining whether the growth of the crop at an additional specific time interval is on track with the new predicted growth of the crop at the additional specific time interval; and
adjusting an allocation of the resource or an additional resource for growing the crop in response to determining that the constraint on the resource or an additional constraint on the additional resource has not been reached in order to realign the growth of the crop at the additional specific time interval with the new predicted growth of the crop at the additional specific time interval.

15. The system of claim 11, wherein the one or more specifications include at least one of a crop specie of the crop, a grow cycle length of the crop, a geographical location for growing the crop, or a growth medium for growing the crop, and wherein the one or more variables include a price of a utility service provided for growing the crop or a weather pattern at the geographical location.

16. The system of claim 11, wherein the one or more constraints include at least one of daily budget for a utility service used for growing the crop, maximum water use for growing the crop, or target cost per unit weight of the crop produced.

17. The system of claim 11, further comprising a near infrared (NIR) camera that is mounted on stationary structure or an autonomous drone, wherein the determining includes determining a growth of at least one plant via a normal difference vegetative index (NDVI) that is generated using infrared data of at least one plant as captured by the NIR camera, the NDVI providing a visualization of a ratio of visible light to NIR light that is reflected by the at least one plant that is used to calculate a metabolic rate of photosynthesis for the at least one plant.

18. The system of claim 11, further comprising a light detection and ranging (LIDAR) sensor that is mounted on stationary structure or an autonomous drone, wherein the determining includes determining crop density based on sensor readings from the LIDAR sensor, the crop density indicating an area of low light or an area of low nutrient absorption by at least one plant.

19. The system of claim 11, further comprising an optical sensor that is mounted on stationary structure or an autonomous drone for obtaining images of the crop, wherein the determining includes processing the images obtained by the optical sensor via a computer vision algorithm to identify a specie of crop, a quantity of the crop, or one or more states associated with the crop, wherein the states includes at least one of an eddy current that causes heat collection in a particular growing area for the crop, necrosis in a leave of a plant of the crop, or chlorosis in a leave of the plant of the crop.

20. One or more non-transitory computer-readable media storing computer-executable instructions that upon execution cause one or more processors to perform acts comprising:
generating a simulation using a machine learning algorithm to determine whether one or more specifications and one or more constraints on resources that regulate a growth of a crop result in a grow solution for the crop, the simulation being further constrained by historical data on one or more variables that affect crop production, the one or more specifications including at least one of a crop specie of the crop, a grow cycle length of the crop, a geographical location for growing the crop, or a growth medium for growing the crop, the one or more constraints including at least one of daily budget for a utility service used for growing the crop, maximum water use for growing the crop, or target cost per unit weight of the crop produced, the one or more variables including a price of a utility service provided for growing the crop or a weather pattern at the geographical location;
receiving a modification to at least one constraint following the simulation failing to generate a grow solution for the crop;
running the simulation to predict growth of the crop at specific time intervals of a grow cycle for the crop following the simulation generating a grow solution for the crop;
monitoring usage of resources and growth of the crop at the specific time intervals during a production of the crop;
determining whether the growth of the crop at the specific time interval is on track with a predicted growth of the crop at the specific time interval;
adjusting an allocation of a resource for growing the crop in response to determining that a corresponding constraint on the resource has not been reached in order to realign the growth of the crop at the specific time interval with the predicted growth of the crop at the specific time interval; and
providing an alert in response to determining that the constraint on the resource has been reached.
